(19) United States
(12) Patent Application Publication
(10) Pub. No.: US 2018/0017403 A1
(43) Pub. Date: Jan. 18, 2018

(54) Navigation API for Linking Software Applications

(71) Applicant: Google Inc., Mountain View, CA (US)

(72) Inventors: Eliran Falah, Beit-Arye (IL); Avi Romano, Rehovot (IL)

(21) Appl. No.: 15/620,731

(22) Filed: Jun. 12, 2017

Related U.S. Application Data
(60) Provisional application No. 62/361,218, filed on Jul. 12, 2016.

(51) Int. Cl. G01C 21/36; G06F 9/54; G06F 9/445; H04W 4/02

(52) U.S. Cl. CPC G01C 21/362; H04W 4/02; G06F 9/547; G01C 21/3661; G01C 21/3676; G06F 9/44521; G01C 21/3673

(57) ABSTRACT

Provided are systems and methods for linking two or more software applications using a navigation application programming interface. In one embodiment, a first software application on a computing device can invoke a second software application on the computing device. The invocation causes the second software application to launch on the computing device. The second software application is associated with a navigation service for providing navigation information to the user of the computing device. The first software application can control an interaction of the second software application with a routing engine based at least in part on one or more travel parameters provided to the second software application by the first software application. The first software application can receive travel data associated with the one or more travel parameters. The travel data is determined based at least in part on the interaction of the second software application and the routing engine.

### PRIORITY CLAIM

The present application is based on and claims priority to U.S. Provisional Application 62/361,218 having a filing date of Jul. 12, 2016, which is incorporated by reference herein.

### FIELD

The present disclosure relates generally to application programming interfaces for providing navigation information.

### BACKGROUND

Applications implemented on computing devices, such as mobile computing devices (e.g., smartphones, tablets, smart watches, etc.) have been developed for a variety of purposes, including business, social, health, and other purposes. These applications can provide a user interface (e.g., a graphical user interface) for presenting information to a user as well as allowing the user to interact with the application. Popular applications for mobile computing devices include maps applications that make varied geographic information (e.g., current location information presented on a map) available to users.

Application programming interfaces can allow applications implemented on computing devices to interact with various services to provide information and functionality to a user. Application programming interfaces can provide a tool for developers to easily embed information, programming, services, frameworks, and structures into applications for access by the user. For example, a map service provider can provide a maps application programming interface that can be used by third parties to communicate navigation data from the map service provider to an application developed by the third party.

### SUMMARY

Aspects and advantages of embodiments of the present disclosure will be set forth in part in the following description, or may be learned from the description, or may be learned through practice of the embodiments.

One example aspect of the present disclosure is directed to a non-transitory computer-readable medium storing computer-readable instructions that implement an application programming interface for linking two or more software applications executed on one or more computing devices. The one or more computing devices can include one or more processors and a display device. The application programming interface can include instructions for invoking, by a first software application associated with a computing device, a second software application associated with the computing device. The invocation of the second software application causes the second software application to launch on the computing device. The second software application is associated with a navigation service for providing navigation information to the user of the computing device. The instructions are further for controlling, by the first software application, an interaction of the second software application with a routing engine based at least in part on one or more travel parameters provided to the second software application by the first software application. The instructions are further for receiving, by the first software application, travel data associated with the one or more travel parameters. The travel data is determined based at least in part on the interaction of the second software application and the routing engine.

Other example aspects of the present disclosure are directed to computer-implemented methods, systems, apparatus, tangible, non-transitory computer-readable media, user interfaces, memory devices, and electronic devices for implementing a navigation API to link two or more software applications.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an overview of an example system for linking two or more software applications using an application programming interface according to example embodiments of the present disclosure;

FIGS. 2-4 depict example graphical user interfaces associated with software applications linked using a navigation application programming interface according to example embodiments of the present disclosure;

FIG. 5 depicts a block diagram of an example user device implementing a software application according to example embodiments of the present disclosure;

FIGS. 6-7 depicts example implementations of a navigation application programming interface according to example embodiment of the present disclosure; and

FIG. 8 depicts a flow diagram of an example method according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to application programming interfaces (“APIs”) for linking software applications implemented on a user computing device, such as web-based software applications implemented in a browser, locally-stored software applications, and other applications. For instance, a first software application executed on the user computing device can invoke a second software application via an API call to launch the second software application on the user computing device. The first software application can be associated with a separate entity relative to the second software application. In some embodiments, the API can allow developers to include a linking element within a user interface of the first software application. The linking element can be a selectable user interface element (e.g., a button or other user interface element) operable to link the first and second software applications. For instance, upon an interaction with the linking element by a user of the first software application, the second software application can be launched on the user computing device and/or brought to the foreground of the user interface of the user computing device.

The second software application can implement aspects of a navigation service for providing navigation information to a user. In some implementations, the second software application 110 can be the Waze© mobile application developed by Waze Mobile Ltd. For instance, the second software application can be configured to present navigation information (e.g., through a graphical user interface component or through audio and/or vibratory cues) based on routing information and/or travel data to provide a navigation service the second software application. A navigation service can be an application (e.g. a software application) that provides navigation information that can be used to guide a user from an origin and a destination. In some embodiments, the navigation service embedded in the software application can provide navigation information (e.g., turn-by-turn navigation information) to a user as a user traverses along a navigation route or other path. More particularly, in some embodiments, the navigation service can receive a route directing a user from an origin location (e.g. a current location of the user or other location) to a destination. As one example, the route can include a sequence of steps, each describing a route portion (e.g., name or number of the road, distance, travel time, speed limit) and a maneuver (e.g., left turn, merge right, proceed straight) to access the next route portion. The navigation service can provide the route to a user through a graphical user interface and via one or more cues (e.g., audio or video cues) to guide the user from an origin to a destination.

The API, when invoked by the first software application, can permit control of the second software application by the first software application. For instance, in implementations wherein the second software application is associated with a navigation service, the API can include one or more sets of instructions for controlling an interaction of the second software application with a routing engine implemented by a navigation data provider or other source (e.g., a local source of navigation information). In such implementations, upon an interaction by the user with the linking element within the first software application, the first software application can provide one or more travel parameters to the second software application. The travel parameters can include a destination location (e.g. latitude, longitude coordinates), a search query, or other suitable travel parameters. As indicated, in some implementations, a user interaction with the linking element can further cause the second software application to launch on the user device, and for the second software application to be brought to the foreground of the user interface associated with the user device. In this manner, the user may view and/or interact with the second software application.

The travel parameters can be provided by the second software application to the routing engine along with instructions specifying one or more actions to be performed by the routing engine. The routing engine can determine travel data associated with the travel parameters. For instance, the travel data can include routing information, such as one or more travel routes to the destination location, an estimated time and/or distance remaining to an arrival by the user at the destination location (“ETD information”), one or more navigation instructions (e.g. next navigation action instructions, an estimated time and/or distance remaining to the next navigation action, etc.), and/or other suitable travel data. In some implementations, the travel data can include a visual representation of the one or more travel routes, such as map data for presentation in conjunction with the route(s) and/or other information. As another example, when the travel parameters are associated with a search query by the user, the travel data can include one or more search results associated with the search query.

At least a portion of the routing engine associated with the navigation data provider can be stored locally on the user computing device. In some implementations, the routing engine can be associated with one or more remote computing devices, such as one or more web servers. For instance, the navigation data provider can be associated with a web server that hosts a geographic information system. In this manner, the routing engine can leverage the geographic information system to determine the travel data (e.g. routing information, search results, and/or other suitable travel data).

The travel data can be received by the second software application, and passed to the first software application via the API. The first software application can present at least a portion of the travel data within a user interface of the first software application. For instance, the first software application can provide for display a visual representation of the one or more travel routes, ETD information, navigation instructions, and/or other suitable travel data. In some implementations, the first software application can present the at least a portion of the travel data through audio and/or vibratory cues.

The API can further allow for developers to implement a linking element within the second software application. For instance, upon a user interaction with the linking element of the first software application, a session between the first and second software applications can be initialized or opened. The open session can signify a coordination of the software application through use of the API. In this manner, when the second software application is launched and brought to the foreground via the API call of the first software application, the second software application can present a linking element within a user interface of the second software application. Similar to the linking element of the first software application, the linking element of the second software application can be a selectable user interface element displayed within the user interface of the second software application. In this manner, a user interaction with the linking element in the second software application can cause the first software application to be brought to the foreground of the user interface of the user computing device, such that the user can view and/or interact with the first software application. In this manner, the linking elements can allow for a simple and efficient way for the user to switch between the first and second software applications.

During an open session between the first and second software applications, one or more API calls may be performed to update the travel data. For instance, during an open session, one or more updated travel parameters (e.g. updated destination locations and/or search queries) can be specified by the user through an interaction by the user with the first or second software applications. In this manner, during the open session, the first and second software applications can coordinate via the API to update the travel data for presentation by the first software application. As an example, if the user specifies one or more update travel parameters from within the first software application during an open session, the updated travel parameters can be provided to the second software application via the API, and the updated travel data (e.g. as determined by the interaction of the second software application and/or the routing engine) can be provided back to the first software application via the API. As another example, if the user specifies one or more updated travel parameters from within the second software application during an open session, updated travel data can be determined and provided to the first software application via the API.

In some implementations, a user interaction with the linking element of the second software application can cause the first software application to present the at least a portion of the travel data. For instance, in response to a user selection of the linking element of the second software application (e.g. when the second software application is at the foreground of the user interface of the user computing device), the first software application can load and present (e.g. provide for display) the at least a portion of the travel data. The first software application can then be brought to the foreground of the user interface of the user computing device, such that the user can view and/or interact with the at least a portion of the travel data as presented by the first software application. In implementations wherein the at least a portion of the travel data is presented by audio or vibratory cues, the audio and/or vibratory cues can be provided to the user upon an interaction by the user with the linking element of the second software application.

In this manner, according to particular aspects of the present disclosure, the API can include sets of computer-readable instructions that when executed by one or more processors facilitate integration of a navigation experience into a developer's software application. The sets of instructions, when implemented by one or more processors, can govern interaction by the software application with the navigation data provider via the API as well as the display and/or delivery of navigation information to the user as part of the software application.

More particularly, example instructions associated with an API that are facing a developer of a software application can include instructions specifying one or more parameters that govern an invocation of a second software application from within a first software application. The API can further include instructions specifying one or more parameters that control the interaction of the second software application with the routing engine provided by the navigation data provider.

In this way, the API according to example embodiments of the present disclosure can have a technical effect of linking a first and second software application, and facilitating the integration of a navigation experience provided by a navigation data provider associated with the second software application in the first software application. The API can allow for the customization of the navigation service for various end use needs, such as for ride sharing applications, shipping/delivery applications, social applications, and other end use applications.

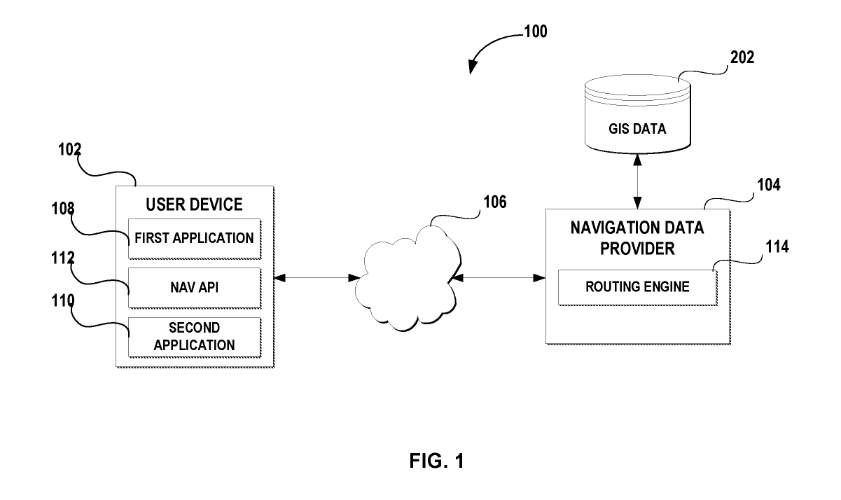

With reference now to the figures, example aspects of the present disclosure will be disclosed in greater detail. For instance, FIG. 1 depicts an overview of an example system 100 for linking one or more software applications according to example embodiments of the present disclosure. The system 100 can include a user device 102 that can receive navigation data from a navigation data provider 104 via a communication network 106. The user device 102 can be, for instance, a smartphone, tablet, wearable device, laptop, desktop, mobile device, device capable of being carried by a user while in operation, display with one or more processors, vehicle system, or other user device.

A first software application 108 and a second software application 110 can be implemented on the user device 102. The first software application 108 can be, for instance, a mapping application, a browser, a ride share application, an application used to assist with delivery, a social media application or other software application that may need to provide navigation information to a user. The second software application 110 can implement a navigation service for providing navigation instructions to a user. The software applications 108, 110 can be stored locally on the user device 102 or can be, for instance, web applications accessed via a web browser implemented on the user device 102. In some embodiments, the software applications 108, 110 can be developed by separate entities. For instance, the first software application 108 can be developed by a third party entity that is independent of and/or not affiliated with an entity associated the second software application 110 and the navigation data provider 104.

The first software application 108 can call a navigation API 112 to invoke the second software application 110 and/or to control an interaction of the second software application 110 with a routing engine 114 associated with the navigation data provider 104. In this manner, the navigation API 112 can be used by the first software application 108 to cause the second software application 110 to access and provide navigation data from the navigation data provider 114 via the communication network 116. Example aspects of the present disclosure are discussed with accessing data from a remote navigation data provider 114 for purposes of illustration and discussion. Those of ordinary skill in the art, using the disclosures provided herein, will understand that the API 112 can access data from other sources, such as local sources or applications located on the user device 102.

The second software application 110 can be configured to present navigation information (e.g., turn-by-turn navigation information) to a user in real time or near real time as a user or vehicle carrying the user device 102 traverses along a route from an origin to one or more destinations. The second software application 110 can include a graphical user interface component for presenting the navigation information to the user on one or more display devices. Additionally or alternatively, the second software application can provide audio guidance or other notifications (e.g., vibratory notifications) to the user indicative of navigation information (e.g., turn-by-turn) directions.

According to example embodiments of the present disclosure, the navigation API 112 can facilitate an invocation of the second software application 110 by the first software application 108. The invocation can cause the second software application to launch and/or execute on the user device 102. The invocation can further cause the second software application 110 to be brought to the foreground of a user interface of the user device 102, such that the user can view and/or interact with the second software application 110. For instance, if the second software application 110 is not currently running on the user device 102, the second software application 110 can be launched and brought to the foreground of the user interface responsive to the invocation. If the second software application 110 is currently running on the user device 102, the second software application 110 can be brought to the foreground of the user interface responsive to the invocation.

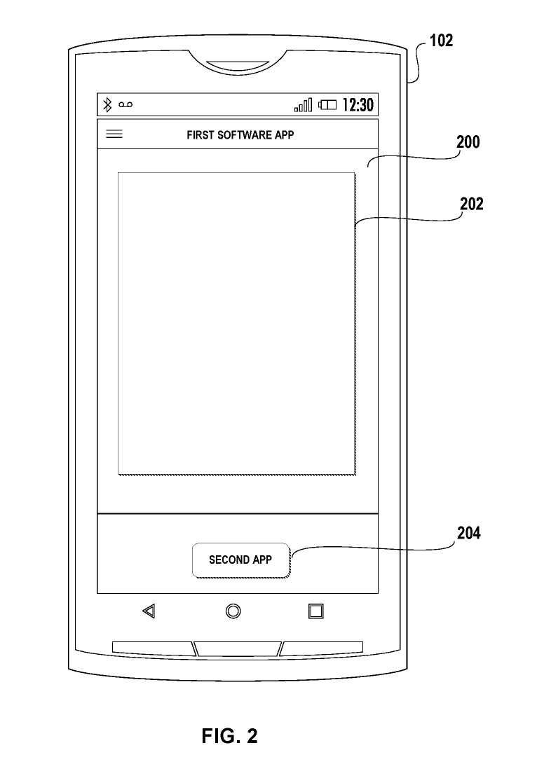

The invocation can occur responsive to a user interaction with a linking element displayed within a user interface of the first software application 108. For instance, FIG. 2 depicts an example graphical user interface component 200 of the first software application 108 according to example embodiments of the present disclosure. The graphical user interface component 200 can be displayed on a display device of the user device 102. The graphical user interface component can include a plurality of interface elements 202 that provide information associated with the first software application 108.

The graphical user interface component 200 can further include a linking element 204 configured to link or otherwise connect the first software application 108 and the second software application 110. As indicated the linking element 204 can be a selectable interface element capable of receiving an input by the user. Upon a user interaction with linking element 204, the second software application 110 can be launched on the user device 102 and/or brought to the foreground of the user interface of the user device 102.

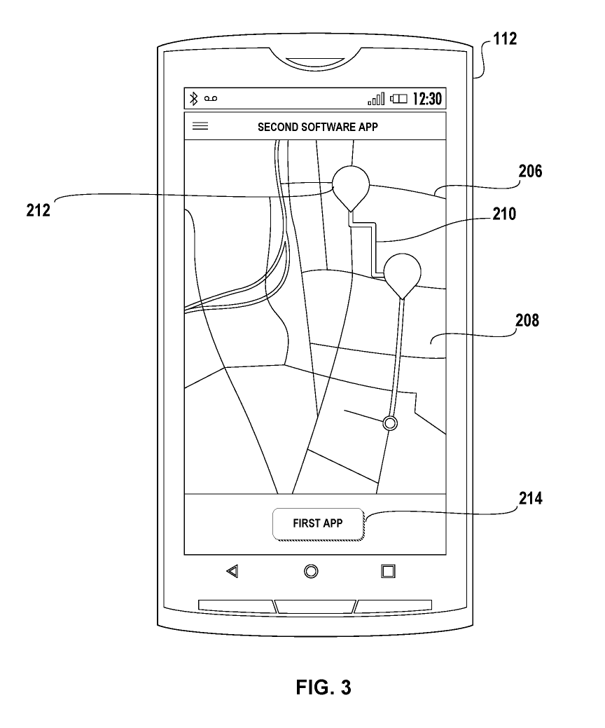

FIG. 3 depicts an example graphical user interface component 206 of the second software application 110 according to example embodiments of the present disclosure. The graphical user interface component 206 can be displayed on a display device of the user device 102. The graphical user interface component 200 can include various interface elements that provide navigation information to a user as part of a navigation service. As shown in FIG. 2, the graphical user interface component 206 includes a map 208 as well as a route 210 to a destination location 212 presented on the map 208. The route 210 is displayed on a top down view of the map 208 to provide a route overview.

According to example embodiments of the present disclosure, data associated with the map 208, the route 210, and other navigation information can be obtained from a navigation data provider 114. As will be described in more detail below, the data can be obtained responsive to a call to API 112 invoked by the first software application 108. For instance, the API 112 call can include or otherwise be associated with one or more travel parameters (e.g. destination location 212). Responsive to receiving the travel parameters and/or the API 112 call from the first software application 108, the second software application 110 can query the navigation data provider 114 for travel data associated with the API 112 call.

Similar to the graphical user interface component 200 associated with the first software application 108, the graphical user interface component 206 can include a linking element 214. The linking element 214 can be selected by the user to return to the first software application 108 (e.g. to bring the first software application 108 to the foreground of the user interface of the user device 102). In some implementations, the linking element 214 can be presented within the graphical user interface component 206 responsive to the API 112 call by the first software application 108. For instance, the linking element 214 can be presented within the graphical user interface component 206 only during an open session between the first software application 108 and the second software application 110 as facilitated by the API 112.

It will be appreciated that the graphical user interface component 206 is intended for illustrative purposes only. In particular, it will be appreciated that the second software application 110 can have various other suitable interfaces that present suitable navigation data in a number of manners. For instance, the second software application may include a navigation mode wherein turn-by-turn instructions associated with the route 210 are presented to the user. As another example, the second software application 110 may include an interface for presenting navigation data in text form, such as written instructions for traversing route 210. As yet another example, the second software application 110 may include an interface for receiving a search query and presenting search results determined based at least in part on the search query.

Referring back to FIG. 1, the API 112 can provide an interface between the first software application 108 and the second software application 110. In this manner, the travel parameters passed to the second software application 110 as part of the API 112 call can be used to automatically determine the travel data (e.g. route 210, mad data 208, etc.) through an interaction with the routing engine 114. The routing engine 114 can be configured to, for instance, compute routes to one or more waypoints, access mapping data, update navigation data based on various navigation events, and respond to requests for navigation data from the second software application 110. In some embodiments, the navigation data provider 104 can include one or more servers, such as web servers. The one or more servers can include one or more processors and one or more memory devices. The one or more memory devices can store computer-readable instruction to implement, for instance, the routing engine 114. In some embodiments, the routing engine 114 can access data associated, for instance, with a geographic information system 118. The geographic information system 118 can include data that indexed by geographic coordinates of its elements. The data associated with the geographic information system 118 can include, for instance, map data, route data, geographic imagery, data associated with various waypoints (e.g., business listing names, addresses, geographic coordinates, etc.), and/or other data.

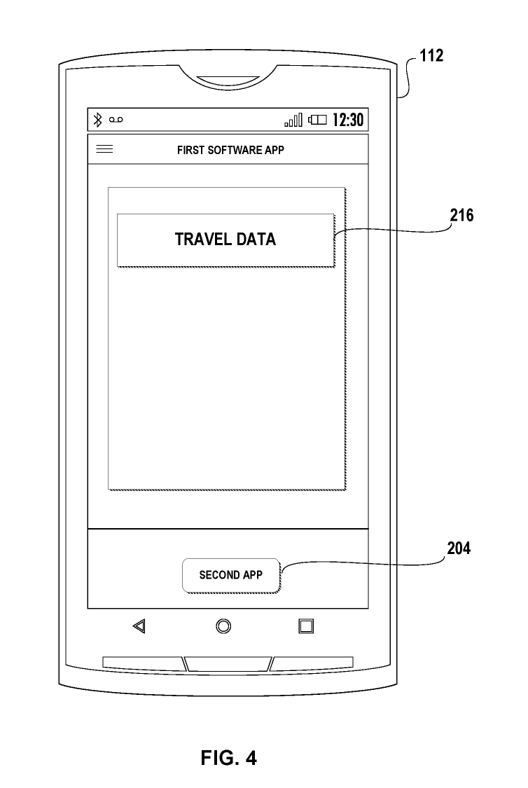

The travel data as determined by routing engine 114 can be provided by to the first software application 108 by the second software application 110 via the API 112. In some implementations, the first software application 108 can present the travel data within the user interface of the first software application 108. For instance, FIG. 4 depicts example graphical user interface 200 of the first software application. As shown, graphical user interface component 200 includes a display of travel data 216. In various implementations, travel data 216 can include a visual representation of map 208 and/or route 210, ETD information, navigation instruction information (e.g. next turn instructions, time to next turn, etc.), one or more search results, and/or other suitable data.

The second software application 110 can interact with the navigation data provider 114 via the network 116. The network 116 can be any type of communications network, such as a local area network (e.g. intranet), wide area network (e.g. Internet), cellular network, or some combination thereof. The network 116 can also include a direct connection. In general, communication can be carried via network 116 using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

FIG. 5 depicts an example user device 102 configured to implement a navigation API 112 according to example embodiments of the present disclosure. As shown, the user device 102 includes an instruction memory 152, one or more processors 154 configured to execute instructions stored in the memory 152, a display device 156, a network interface 158 that supports network communications, and a storage memory 160. The one or more processors 154 can include any suitable processing device, such as a microprocessor, microcontroller, integrated circuit, logic device, or other suitable processing device. For clarity, the instruction memory 152 and the storage memory 160 are illustrated separately. It will be understood, however, that the components 152 and 160 can also be regions within the same memory module. More generally, the user device 102 can include one or more additional processors, memory devices, network interfaces, which may be provided separately or on a same chip or board. The components 152 and 160 can include one or more computer-readable media, including, but not limited to, non-transitory computer-readable media, RAM, ROM, hard drives, flash drives, or other memory devices.

The instruction memory 52 can store sets of instructions of an operating system (OS) 170, a navigation API 130, and a first software application 108 and a second software application 110. The OS 170 can be a mobile OS developed specifically for mobile devices. As such, the OS 170 can include functions that allow the software application to access data such as wireless network parameters (e.g., identity of the wireless network, quality of service), as well as invoke such services as telephony, location determination (e.g., via global positioning service (GPS) or WLAN), wireless network data call origination, etc. In other implementations, the OS 170 is a general-purpose operating system that operates on both mobile and stationary devices, such as smartphones and desktop computers, for example. In some example implementations, the OS includes or based upon an Android® mobile operating system developed by Google Inc. or other operating system to implement an Android operating platform. However, other suitable operating systems can be used without deviating from the scope of the present disclosure.

The first software application 108 can be, for example, a mapping application, a navigation application, ride share application, an application to assist with delivery, a social media application, etc. The second software application 110 can provide a navigation experience from a navigation service. The software applications 108, 110 can be native applications or web-based applications. The first software application 108 can perform a call to API 112 to invoke the second software application 110. In general, the navigation API 112 can be made available to any suitable software application that executes on the user device 102. Also, multiple different software applications may invoke the navigation API 112.

In some implementations, the user device can include a positioning system. the positioning system can include one or more devices or circuitry for determining the position of a device. For example, the positioning device can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, beacons, and the like and/or other suitable techniques for determining position. The positioning system can determine a user location of the user device. The user location can be provided to the navigation data provider 104 for use by the navigation data provider in determining travel data associated with the user device 102.

The navigation API 112 can be implemented as one or several functions, a data structure, etc. Further, the API 112 may include compiled code that executes directly on the processor(s) 154 or, alternatively, instructions in any other form such as a scripting language interpreted at runtime by the applications 108, 110. The API 112 in one example implementation includes well-documented prototypes of several functions which a developer can include in the code of the software applications 108, 110, as well as instructions that implement these functions. In some embodiments, the API 112 can be provided to the developer as a static library.

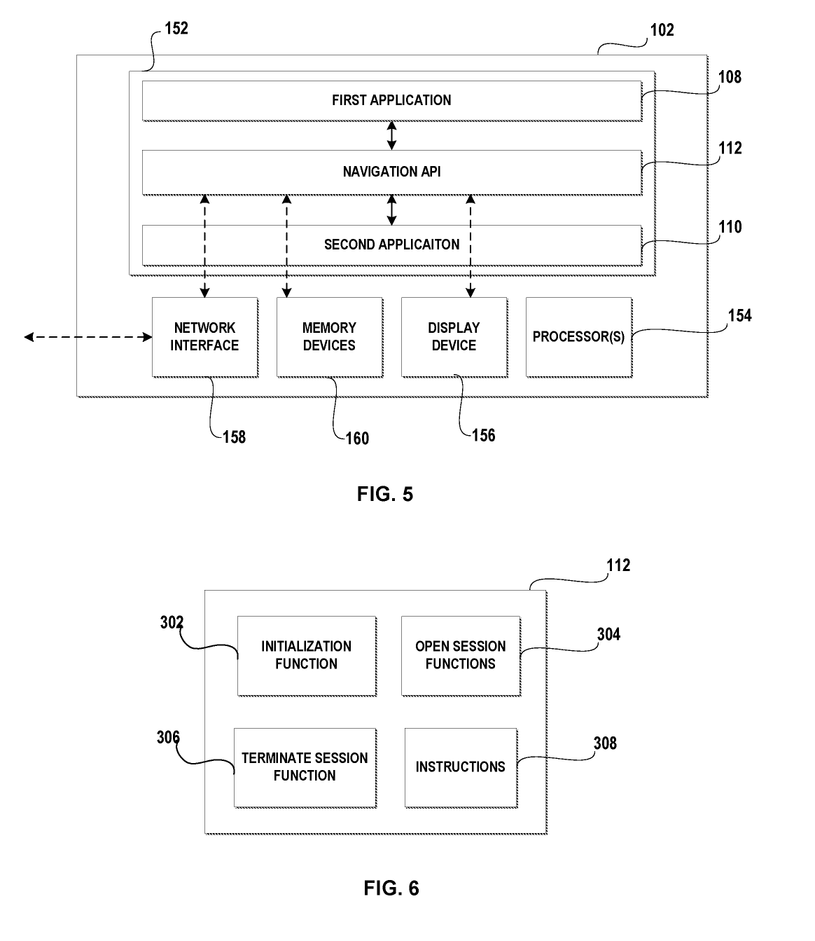

FIG. 6 depicts a block diagram of example sets of instructions that a developer can user to configure a navigation API 112 according to example embodiments of the present disclosure. The sets of instructions can include an initialization function 302, open session functions 304, terminate session functions 306, and various instructions 308. The instructions depicted in FIG. 6 can be used to implement the API 112 in an Android operating system. Such Android implementation can be based on a Messenger Object technique. In such implementation, API 112 can create an asymmetric key for the session, and send it to the second software application 110. Once an initial “handshake” is performed between the applications via the API 112, data provided by the second software application 110 (e.g. travel data) can be encrypted using the asymmetric key. The first software application 108 will then be able to decrypt the data based on a one-way encryption method.

The initialization function 302 can be used to initialize the API with the second software application 110, bind the API 112, and cause the second software application 110 to launch (e.g. responsive to a user interaction with the linking element 204). The initialization function can further be used to navigate or search with the second software application 110 (e.g. via an interaction with the routing engine 114), and to receive travel data from the second software application 110. In some implementations, the initialization function 302 (e.g. initSDK) can be implemented as follows:

public boolean initSDK(Context context, Messenger cbReceivedData,
PendingIntent CallbackIntent, double lon, double lat, String query)

### Return Value:

boolean for success or failed, if failed, you can check in the logcat for errors under the name “TRANSPORTATION”

### Function Parameters:

Context context: Context that the WazeSDKManager will run on
Messenger cbReceivedData: Messenger object that will receive the data from the Waze app (the messages will be decrypted in WazeSDKManager and transfer to cbReceivedData the decrypted payload)
PendingIntent CallbackIntent: Intent to be called when clicking on your app button in Waze
double lon: longitude of the destination to navigate(optional—if query is not null, then it will start search).
double lat: latitude of the destination to navigate(optional—if query is not null, then it will start search).
String query: address text for search (optional—might be null for navigate when using lon,lat)

As indicated, the initialization function 302 can be used to pass the travel parameters (e.g. double lat, double lon, string query, etc.) to the second software application 110. The travel parameters along with other suitable data (e.g. user location data) can be provided to routing engine 114 for determination of suitable travel data. In some implementations, the initialization function 302 can be used to open a session between the first application 108 and the second application 110. The open session can allow for communication between the first application 108 and the second application 110 via the API 112.

During an open session, one or more open session functions 304 can be called to facilitate a determination of updated travel data. For instance, the open session functions 304 can include a new destination function. The new destination function can be used to provide a new destination location during an open session for which a route should be determined. In some implementations, the new destination function can be implemented as follows:

public void driveRequest(double lon, double lat)

### Overview on the Function:

Send a drive message to the Waze app (Note that InitSDK function will navigate when initialize Waze app, so calling again this function will change the route).
This function should be used for new destination in the middle of an open session.

### Function Parameters:

double lon longitude of the destination to navigate.
double lat latitude of the destination to navigate.

Similarly, the open session functions 304 can include a new search query function. The new search query function can be used to provide a new search query during an open session for which new search results should be determined. In some implementations, the new search query function can be implemented as follows:

public void searchRequest(String query)

### Overview on the Function:

Send a search request message to the Waze app. This function should be used for new
search requests in the middle of an open session.

### Function Parameters:

String query address text for search

An open session can be terminated using the terminate session function 306. The terminate session function can be used to terminate the connection between first application 108 and the second application 110. The API 112 can further include further instructions 308 that can be used to implement various other functions. For instance, instructions 308 can include a get App version function that can be used to receive a version number of the second software application. It will be appreciated that instructions 308 can further include various other suitable functions.

As indicated above, the API 112 displayed in FIG. 6 can be implemented using a Messenger Object technique. In some implementations, a developer can create a messenger object and can implement a messenger handler, such that data communicated between the applications can be parsed after decryption. For instance, in a particular embodiment, such techniques can be implemented as follows:

private final Messenger mActivityMessenger = new Messenger(
new MessageHandler(this ));
static class MessageHandler extends Handler {
private final WeakReference<MainActivity> mActivity ;
public MessageHandler(MainActivity activity) {
mActivity = new WeakReference<MainActivity>(activity);
} @
Override
public void handleMessage(Message msg) {
int MessageType = msg.what ;
WazeSDKManager.Waze_Message message =
WazeSDKManager.Waze_Message.values( )[MessageType];
switch (message)
{
case Waze_Message_CONNECTION_STATUS :
{
String ConnectedString = msg.getData( ).getString(
“STATUS” );
boolean IsConnected = Boolean.valueOf(ConnectedString);
break ;
} c
ase Waze_Message_ETA :
{
String strETA = msg.getData( ).getString(
“ETA_MINUTES” );
break ;
} c
ase Waze_Message_INSTRUCTION :
{
String instruction = msg.getData( ).getString(
“INSTRUCTION” );
int instructionCode = Integer.valueOf(instruction);
break ;
}
// This message is received only when the instruction is roundabout (this is
the exit
number)
case Waze_Message_INSTRUCTION_EXIT :
{
String instructionExit = msg.getData( ).getString(
“INSTRUCTION_EXIT” );
int instructionCode = Integer.valueOf(instructionExit);
Log.e(“Transportation” , “INSTRUCTION EXIT MSG : ” +
instructionExit);
break ;
}
case Waze_Message_DISTANCE :
{
String Distance = msg.getData( ).getString(
“DISTANCE_METERS” );
break ;
} c
ase Waze_Message_ROUTE :
{
String RouteGeometry = msg.getData( ).getString(
“GeoJson” );
break ;
}
}

In some implementations, a developer can create a pending intent for the second software application 110 to call responsive to a user interaction with the linking element within the second software application. Such pending intent can be used to return to the first software application 108. For instance, such technique can be implemented as follows:

mCurrentActivity = PendingIntent.getActivity(this , 01, intent,
PendingIntent.FLAG_UPDATE_CURRENT);

In some implementations, a developer can implement the initialization function 302 to initialize the API with the travel parameters, and to navigate to the destination location as follows:

WazeSDKManager.getInstance( ).InitSDK(privatekey ,
MainActivity.this ,
mActivityMessenger , mCurrentActivity, lat, lon);

In some implementations, the travel data provided by the second software application 110 to the first software application 108 can be include various messages as the user traverses the travel route. For instance, the messages can be periodically provided to the second software application 110 by the routing engine 114 to reflect updated travel data as the user travels along the route. Such messages can include messages for distance to the next navigation action to be taken by the user (e.g. a numeric value of distance in meters), an estimated time of arrival at the destination location (e.g. a numeric value of estimated time of arrival in minutes), a connection status (e.g. a Boolean value of true when connected and false when disconnected), and route geometry data (e.g. in a GeoJSON format), and next action instructions (e.g. a numeric value). For instance, the next action instructions can an enumeration of the navigation action types as follows:

public static enum Waze_Instructions_Types
{
NAV_INSTR_NONE,
TURN_LEFT,
TURN_RIGHT,
KEEP_LEFT,
KEEP_RIGHT,
CONTINUE_STRAIGHT,
ROUNDABOUT_ENTER,
ROUNDABOUT_EXIT,
ROUNDABOUT_LEFT,
ROUNDABOUT_EXIT_LEFT,
ROUNDABOUT_STRAIGHT,
ROUNDABOUT_EXIT_STRAIGHT,
ROUNDABOUT_RIGHT,
ROUNDABOUT_EXIT_RIGHT,
ROUNDABOUT_U,
ROUNDABOUT_EXIT_U,
APPROACHING_DESTINATION,
EXIT_LEFT,
EXIT_RIGHT,
WAYPOINT_DELAY,
U_TURN,
NAV_INSTR_COUNT
}

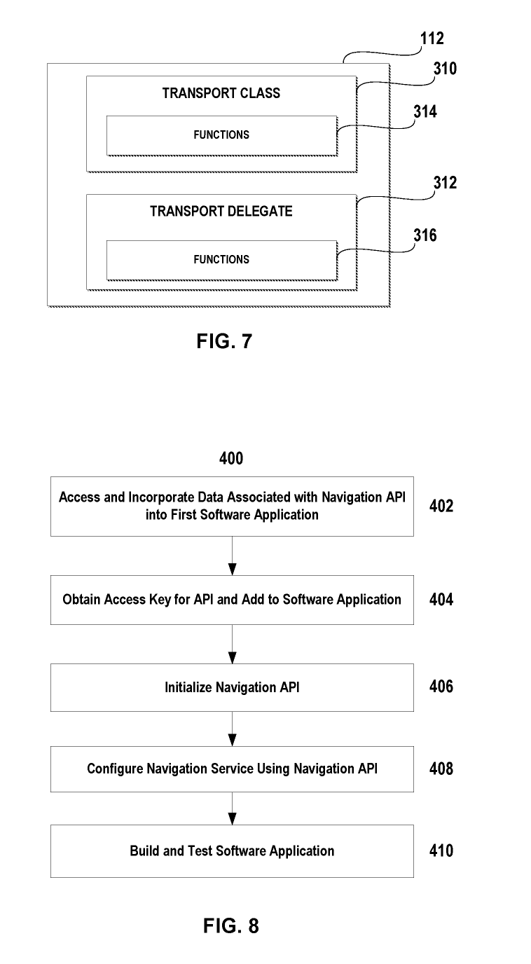

FIG. 7 depicts another example implementation of the API 112. For instance, the API 112 depicted in FIG. 7 can be configured for implementation in an iOS® mobile operating system developed by Apple Inc. Such implementation depicted in FIG. 7 can be based on an URL scheme technique for initializing the second software application 110 from the first software application 108. Communication between the first software application 108 and the second software application 110 can be performed using encrypted bi-directional messaging techniques. In this manner, the API 112 can be configured to encapsulate the communication, and to provide the first software application 108 a framework for simple integration.

As shown in FIG. 7, the API 112 can include a transport class 310 and a transport delegate 312. The transport class 310 can be the main class, and can be used to initialize a session between the first software application 108 and the second software application 110. The transport class 310 can further be used to launch the second software application (e.g. responsive to a user interaction with the linking element 204 of the first software application 108) with a destination location for which a route is to be determined. In some implementations, the transport class 310 can use a shared instance design pattern. Transport class 310 can include one or more functions 314. For instance, the one or more functions can include one or more initialization functions (e.g. a navigation initialization function and a query initialization function), one or more open session functions (e.g. a new address function, a new query function, a stop navigation function, a linking function, and/or other functions), a terminate session function, and/or other functions.

The navigation initialization function can be used to initialize a session, launch the second software application 110, and begin navigating to the specified destination location. In some implementations, the navigation initialization function (e.g. startWithLocation) can be implemented as follows:

(void)startWithLocation :(CLLocation *)location
delegate :(id<WazeTransportDelegate>)delegate returnURL :(NSURL
*)returnURL
Overview
Used to initialize the session with Waze app and launch Waze. Will start
navigation to
specified
location.
Parameters
location : drive destination coordinates
delegate : WazeTransportDelegate used to receive messages
returnURL : URL scheme of 3rd party app, will be used to return to the
app by button.

The query initialization function can be used to initialize a session and launch the second software application 110. The function can further be used to return search results associated with a search query (e.g. an address query). In some implementations, the query initialization function (e.g. startWithAddressQuery) can be implemented as follows:

(void)startWithAddressQuery
:(NSString*)addressQuery
delegate :(id<WazeTransportDelegate>)delegate returnURL :(NSURL
*)returnURL
Overview
Used to initialize the session with Waze app and launch Waze. Will show
search results for
the
provided address query.
Parameters
addressQuery : destination address
delegate : WazeTransportDelegate used to receive messages
returnURL : URL scheme of 3rd party app, will be used to return to the
app by button.

The new address function can be used to update the second software application with a new destination location during an open session, and to begin navigating to the new destination location. In some implementations, the new address function (e.g. setLocation) can be implemented as follows:

(void)setLocation :(CLLocation *)location
Overview
Update Waze app with new destination. Requires active session.
Parameters
location : drive destination coordinates

The new query function can be used to update the second software application 110 with a new address query or other search query, and to receive new search results for the new query. In some implementations, the new query function (e.g. setAddressQuery) can be implemented as follows:

(void)setAddressQuery
:(NSString *)address
Overview
Update Waze app with new address and show search results. Requires
active session.
Parameters
address : address for search

The stop navigation function can be used to stop navigation during an open session, and can be implemented as follows:

-(void)stopNavigation
Overview
Stops navigation.

The linking function can be used to return to the first software application 108 from within the second software application 110. The linking function (e.g. sendReturnRequest) can be implemented as follows:

(void)sendReturnRequest
Overview
If Waze is in foreground, will return to the calling app once receiving this
command.

The terminate session function can be used to terminate an open session between the first software application 108 and the second software application 110. The terminate session function can be implemented as follows:

(void)terminate
Overview
Terminates the connection to Waze and stops listening to messages

Transport delegate 312 can include one or more delegate functions 316. As will be understood by those in the art, developers can implement delegates to act on behalf of, or in coordination with, one or more other objects when the one or more other objects encounter events in a program. In this manner, transport delegate 312 can coordinate with transport class 310 to implement example aspects of the present disclosure. More particularly, transport delegate 312 can be used to receive messages from the second software application 110. In some implementations, the transport delegate 312 and the delegate function 316 can be implemented as follows:

@protocol WazeTransportDelegate
Overview
Use this delegate to receive messages from Waze
(void)wazeTransportDidReceiveMessage :(NSDictionary *)message
Overview
Called whenever new data is available
Parameters
message: will include one or more key/values from Waze
(void)wazeTransportDidUpdateConnection :(BOOL)connected
Overview
Connection state change. If connection is lost (for example if Waze app
was closed),
terminate
the session and start a new one when app is in foreground.
Parameters
connected: YES when session connects successfully, NO when connection
is
lost.
(void)wazeTransportDidReceiveWazeVersion
:(NSString *)version
Overview
Once connected, Waze will send version message.
Parameters
version: The installed Waze version.
Details
Older Waze clients did not support this feature. To determine if installed
Waze supports
version
reporting, check if the following waze url exists (using canOpenURL):
wazeapi2

Still referring to FIG. 7, in a particular implementation, the API 112 can be implemented within the first software application 108 and/or the second software application 110 as follows:

(void)startWaze {
NSURL *url = [NSURL URLWithString:@“transport://”]; //Replace
“transport://” with your URL scheme
CLLocation *location = [[CLLocation
alloc]initWithLatitude:32.196208 longitude:34.878593];
[[WazeTransport sharedInstance] startWithLocation:location
delegate:self
returnURL:url];
}
(void)updateWaze {
[[WazeTransport sharedInstance] setLocation:[[CLLocation
alloc]initWithLatitude:32.196208 longitude:34.878593]];
}
#pragma mark WazeTransportDelegate
(void)wazeTransportDidReceiveMessage :(NSDictionary *)message {
//Message may include one or more of the following keys
NSNumber *distance = message[@“distance”];
NSNumber *instruction = message[@“instruction”];
NSNumber *exitNumber = message[@“exitNumber”]; //used for
roundabout
NSNumber *ETA = message[@“ETA”];
NSString *geoJSON = message[@“Route”];
}
(void)wazeTransportDidUpdateConnection :(BOOL)connected {
if (!connected) {
//terminate
[[WazeTransport sharedInstance] terminate];
//add your code start again by relaunching Waze.
}
}

As indicated above, the travel data communicated to the first software application 108 by the second software application 110 can include one or more messages. For instance, various message types can be provided. In some implementations, the message types can include next action distance messages (e.g. numeric value of distance in meters), time to destination messages (e.g. numeric value of ETA in seconds), route geometry (e.g. GeoJSON format), exit number messages (e.g. numeric value, roundabout exit number for roundabout without turn instruction), and next action messages (e.g. numeric value, enumeration of the type described below):

public static enum Waze_Instructions_Types
{
NAV_INSTR_NONE,
TURN_LEFT,
TURN_RIGHT,
KEEP_LEFT,
KEEP_RIGHT,
CONTINUE_STRAIGHT,
ROUNDABOUT_ENTER,
ROUNDABOUT_EXIT,
ROUNDABOUT_LEFT,
ROUNDABOUT_EXIT_LEFT,
ROUNDABOUT_STRAIGHT;
ROUNDABOUT_EXIT_STRAIGHT,
ROUNDABOUT_RIGHT,
ROUNDABOUT_EXIT_RIGHT,
ROUNDABOUT_U,
ROUNDABOUT_EXIT_U,
APPROACHING_DESTINATION,
EXIT_LEFT,
EXIT_RIGHT,
WAYPOINT_DELAY,
U_TURN,
NAV_INSTR_COUNT
}

In some implementations, the API 112 can include one or more modes of operation. For instance, the API 112 can include a “with data” mode wherein the API can be configured to permit the communication of travel data to the first software application 108. The “with data” mode can further allow for the linking elements 204, 214 to enable switching between the applications. The API 112 can further include a “without data” mode, wherein the travel data is not communicated to the first software application 108. The “without data” mode can include the linking elements 204, 214 for switching between the applications. In this manner, the first software application 108 will not display travel data when associated with the API 112 while in the “without data” mode.

FIG. 7 depicts a flow diagram of one example method (400) of linking one or more software applications using a navigation API according to example embodiments of the present disclosure. The method (400) can be implemented using, for instance, the API 112 depicted in FIGS. 5 and 6. FIG. 7 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At (402), the method can include accessing and incorporating data (e.g., files) associated with the navigation API 112 into the first software application 108. For instance, a user can download files associated with the navigation API 112, for instance, over a network (e.g., the Internet) and can provide the navigation API files into a subdirectory under a gradle root associated with the software application. Libraries associated with the navigation API 112 and third-party dependencies can be added to the software application.

At (404), an access key for enabling the navigation API 112 can be obtained. In some embodiments, the access key can be obtained from the navigation data provider. The access key can be added to the first software application 108, for instance, to the androidmanifest.xml associated with the software application.

At (406), the developer can initialize the API 112. For instance, the developer can implement an initialization function using one or more of the API 112 implementations as described above. In some implementations, the developer can implement a linking element within the first software application 108. The linking element can be a selectable user interface element operable to initialize a session between the first software application 108 and the second software application 110, and to launch the second software application via the navigation API 112. For instance, the developer can configure the first software application 108 to call the API 112 initialization function(s) responsive to a user interaction with the linking element.

Once the navigation API 112 is initialized, the developer can implement API 112 to control and configure the navigation service as shown at (408). For example, various functions can be specified to determine travel parameters (e.g. destination location, search query, etc.) to be provided to the second software application 110. In this manner, the travel parameters can be provided by calling one or more initialization functions and/or one or more open session functions associated with the API 112. At (410), the method can include building and testing the first software application 108 with the coordination and communication between the second software application 110 and the navigation service associated with the second software application 110.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A non-transitory computer-readable medium storing computer-readable instructions that implement an application programming interface for linking two or more software applications executed on one or more computing devices, the one or more computing device have one or more processors and at least one display device, the application programming interface comprising instructions for:
invoking, by a first software application associated with one or more computing devices, a second software application, the invocation of the second software application causing the second software application to launch on the one or more computing devices, the second software application being associated with a navigation service for providing navigation information to the user of the computing device;
controlling, by the first software application, an interaction of the second software application with a routing engine based at least in part on one or more travel parameters provided to the second software application by the first software application; and
receiving, by the first software application, travel data associated with the one or more travel parameters, the travel data being determined based at least in part on the interaction of the second software application and the routing engine.

2. The non-transitory computer-readable medium of claim 1, wherein the one or more travel parameters comprise a destination location associated with the user.

3. The non-transitory computer-readable medium of claim 2, wherein the travel data comprises navigation data associated with one or more travel routes to the destination location.

4. The non-transitory computer-readable medium of claim 3, wherein the travel data comprises at least one of a visual representation of the one or more travel routes, an estimated time or distance remaining to arrival at the destination location, navigation instructions, or an estimated time or distance remaining to a subsequent navigation action to be taken by the user.

5. The non-transitory computer-readable medium of claim 1, the application programming interface further comprising instructions for:
providing, by the second software application, the one or more travel parameters to the routing engine;
receiving, by the second software application, the travel data from the routing engine; and
providing, by the second software application, the travel data to the first software application.

6. The non-transitory computer-readable medium of claim 1, the application programming interface comprising instructions for presenting, by the first software application, at least a portion of the travel data within a user interface associated with the first software application.

7. The non-transitory computer-readable medium of claim 1, the application programming interface comprising instructions for:
receiving, by the first software application, data indicative of a user interaction with a first linking element displayed within the user interface of the first software application; and
wherein invoking the second software application is performed responsive to receiving the data indicative of the user interaction with the linking element.

8. The non-transitory computer-readable medium of claim 7, the application programming interface comprising instructions for:
receiving, by the second software application, data indicative of a user interaction with a second linking element displayed within a user interface of the second software application; and
wherein the user interaction with the second linking element causes the first software application to be displayed by the one or more computing devices.

9. The non-transitory computer-readable medium of claim 1, wherein the invocation of the second software application by the first software application further causes the second software application to be displayed by the one or more computing devices.

10. The non-transitory computer-readable medium of claim 1, wherein the one or more travel parameters comprise a search query specified by the user.

11. The non-transitory computer-readable medium of claim 10, wherein the travel data comprises one or more search results determined based at least in part on the search query.

12. A computing device, comprising:
a display device;
a network interface;
one or more processors; and
one or more memory devices, wherein the one or more memory devices store computer-readable instructions that implement an application programming interface invoked by a software application to obtain navigation information from a navigation data provider to provide a navigation service as part of the software application, the instructions comprising:
invoking, by a first software application associated with the computing device, a second software application associated with the computing device, the invocation of the second software application causing the second software application to launch on the computing device, the second software application being associated with a navigation service for providing navigation information to the user of the computing device;
controlling, by the first software application, an interaction of the second software application with a routing engine based at least in part on one or more travel parameters provided to the second software application by the first software application; and
receiving, by the first software application, travel data associated with the one or more travel parameters, the travel data being determined based at least in part on the interaction of the second software application and the routing engine.

13. The computing device of claim 12, wherein the one or more travel parameters comprise a destination location associated with the user.

14. The computing device of claim 12, wherein the travel data comprises navigation data associated with one or more travel routes to the destination location.

15. The computing device of claim 14, wherein the travel data comprises at least one of a visual representation of the one or more travel routes, an estimated time or distance remaining to arrival at the destination location, navigation instructions, or an estimated time or distance remaining to a subsequent navigation action to be taken by the user.

16. The computing system of claim 12, wherein invoking, by a first software application associated with the computing device, a second software application associated with the computing device comprises calling one or more initialization functions associated with the application programming interface.

17. A method of linking two or more software applications on a computing device having one or more processors, the method comprising:
accessing data associated with a navigation application programming interface;
initializing the navigation application programming interface, wherein initializing the navigation application programming interface comprises implementing a linking element within a user interface of a first software application on the computing device, the linking element operable to invoke a second software application on the computing device via one or more calls to the navigation application programming interface;
configuring an interaction between the second software application and a routing engine associated with a navigation service associated with the second software application, wherein the interaction is determined based at least in part on one or more travel parameters provided to the second software application from the first software application.

18. The method of claim 17, wherein the method comprises:
obtaining an access key for enabling operation of the navigation application programming interface; and
adding the access key to the software application.

19. The method of claim 17, wherein the method comprises initializing the navigation application programming interface using one or more initialization functions associated with the navigation application programming interface.

20. The method of claim 17, wherein the method comprises configuring an interaction between the second software application and a routing engine associated with a navigation service associated with the second software application using one or more open session functions associated with the navigation application programming interface.
